(19) United States
(12) Patent Application Publication
(10) Pub. No.: US 2003/0100216 A1
(43) Pub. Date: May 29, 2003

(54) Jumper cable apparatus having a protective device

(76) Inventor: I Chang Chang, Chong Ho City (TW)

Correspondence Address: I Chang Chang, P.O. Box 10-69, Chong Ho,, Taipei Hsien, 235, TW

(21) Appl. No.: 09/990,276

(22) Filed: Nov. 23, 2001

(51) Int. Cl. H01R 3/00

(52) U.S. Cl. 439/489

(57) ABSTRACT

A jumper cable apparatus includes two couplers, and a device for shutting off an electric coupling between the couplers when the couplers are wrongly coupled to electric poles, or for electrically coupling the couplers together when the couplers are coupled to correct electric poles. A relay is coupled between the couplers, and is coupled to another relay for actuating the relay to shut off the electric coupling between the couplers. A positive voltage detecting device may be used for detecting whether the couplers have been correctly coupled to the electric poles or not.

### BACKGROUND OF THE INVENTION

1. Field of the Invention

The present invention relates to a jumper cable, and more particularly to a jumper cable apparatus having a protective device.

2. Description of the Prior Art

Typical jumper cables comprise a pair of electric wires, and two pairs of clamps secured to the ends of the pair of electric wires respectively for coupling the terminals of a spare battery to the battery of the vehicle or directly to the vehicle for starting the vehicle. When the clamps are clamped onto the terminals of the vehicle battery, sparks may be generated. In addition, when the clamps are clamped onto the wrong terminals of the vehicle battery, the electric facilities of the vehicle, such as the radio, the remote control system, etc. of the vehicle may be seriously damaged.

The present invention has arisen to mitigate and/or obviate the afore-described disadvantages of the conventional jumper cables.

### SUMMARY OF THE INVENTION

The primary objective of the present invention is to provide a jumper cable apparatus including a protective device for preventing the terminals of the spare battery from being wrongly coupled to the terminals of the vehicle.

In accordance with one aspect of the invention, there is provided a jumper cable apparatus comprising a first coupler, a second coupler, and means for shutting off an electric coupling between the first and the second couplers when the first and the second couplers are wrongly coupled to electric poles, or for electrically coupling the first and the second couplers together when the first and the second couplers are coupled to correct electric poles.

The shutting off means includes a first relay coupled between the first and the second couplers, and means for actuating the first relay. The actuating means includes a second relay coupled to the first relay for actuating the first relay, and a positive voltage detecting device coupled to the second relay for actuating the second relay when the first and the second couplers have been correctly coupled to the electric poles.

A device may further be provided and used for indicating a correct coupling of the first and the second couplers to the electric poles. A device may further be provided for generating a warning signal when the first and the second couplers are wrongly coupled to the electric poles.

A negative voltage detecting device is further provided and coupled between the first and the second couplers and coupled to the warning signal generating means for actuating the warning signal generating means when the first and the second couplers are wrongly coupled to the electric poles.

A protective device is further provided and coupled to the negative voltage detecting device for shutting off the an electric coupling between the first and the second couplers when the negative voltage detecting device is actuated.

The positive voltage detecting device includes a first transistor and a second transistor coupled to the first and the second couplers respectively, the positive device includes a third and a fourth transistors coupled to the first and the second transistors for selectively disabling the first and the second transistors. A device is further provided for compulsorily electrically coupling the first and the second couplers together.

Further objectives and advantages of the present invention will become apparent from a careful reading of a detailed description provided hereinbelow, with appropriate reference to accompanying drawings.

### BRIEF DESCRIPTION OF THE DRAWINGS

FIG. 1 is a perspective view of a jumper cable apparatus in accordance with the present invention;

FIG. 2 is a plan view of the jumper cable apparatus;

FIG. 3 is a block diagram illustrating the circuits for the protective device for the jumper cable apparatus; and

FIG. 4 is an electric circuit of the protective device for the jumper cable apparatus.

### DETAILED DESCRIPTION OF THE PREFERRED EMBODIMENT

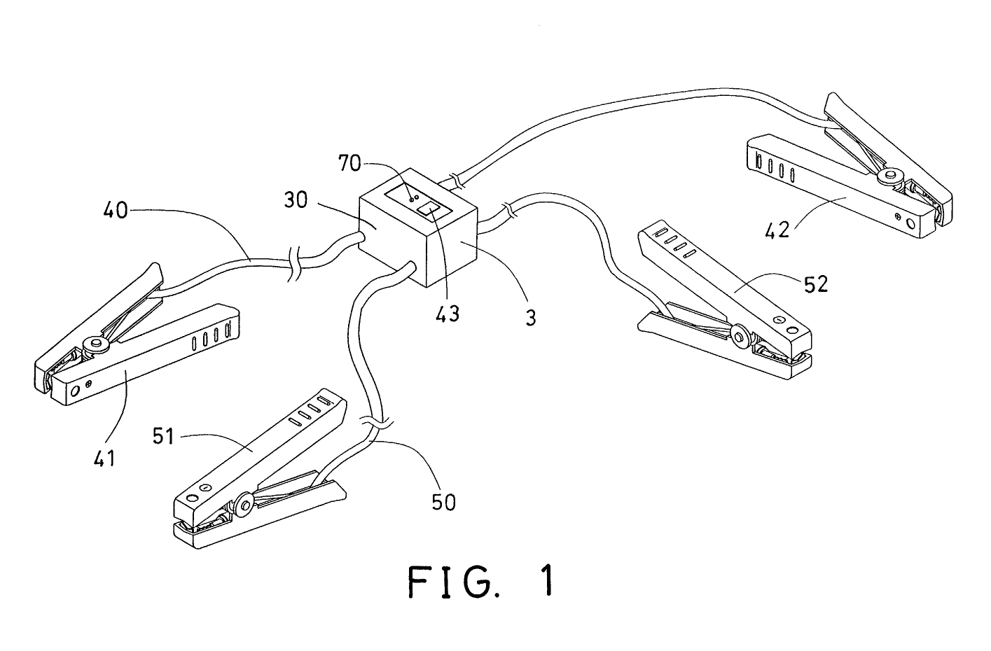

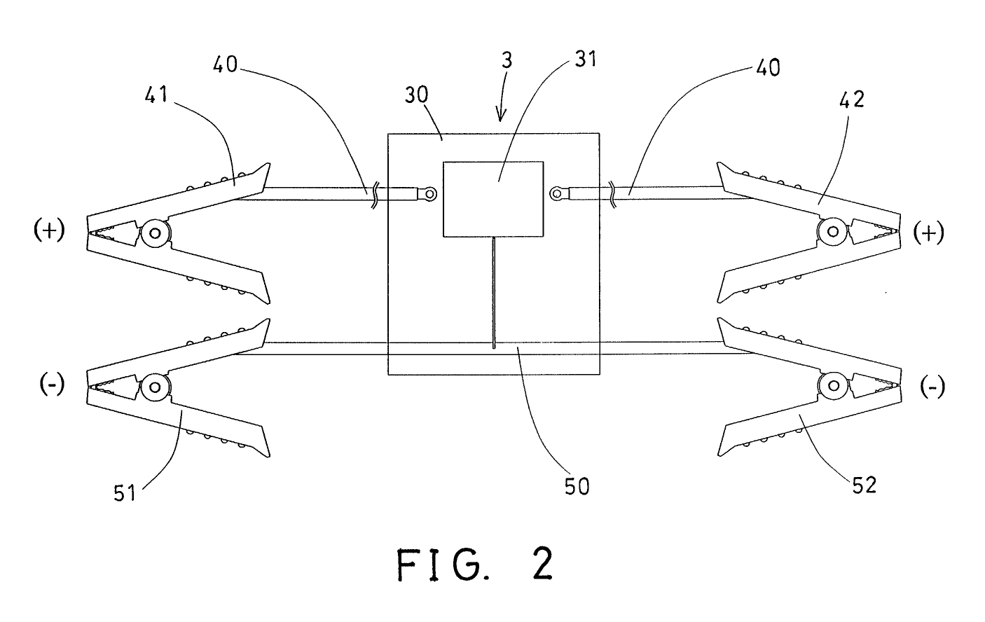

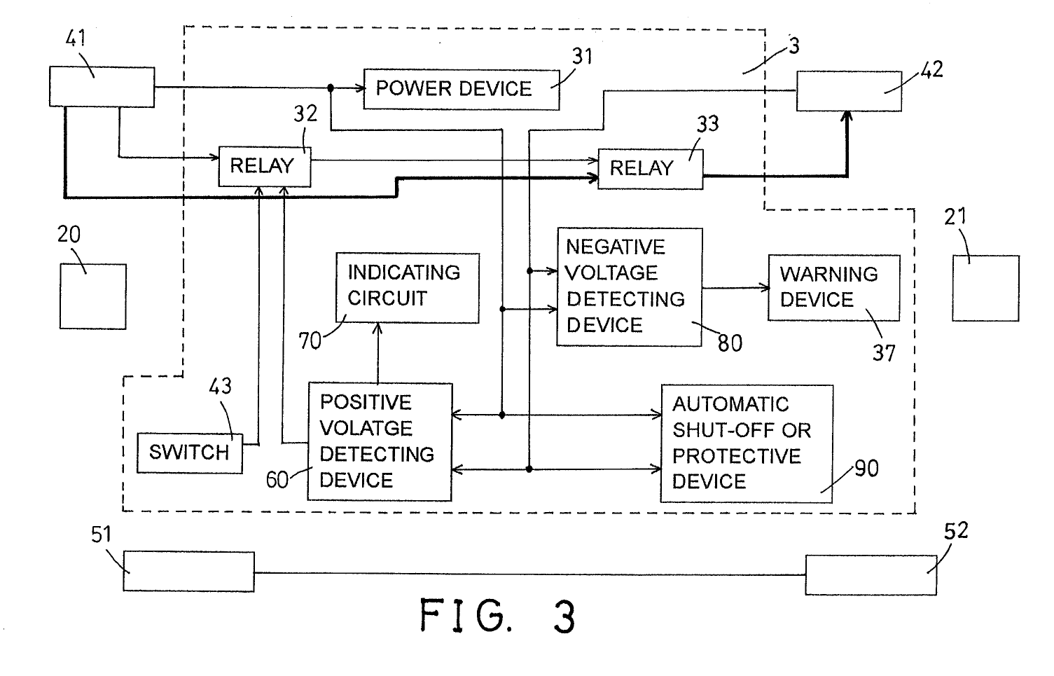

Referring to the drawings, and initially to FIGS. 1 and 2, a jumper cable apparatus in accordance with the present invention comprises a protective device 3 including a housing 30 for receiving various kinds of elements, particularly the electric elements of the protective device 3, and two clamps or plugs or sockets or couplers 41, 42 coupled to the protective device 3 with electric wires 40, and another electric wire 50 coupling the protective device 3 to the other couplers 51, 52. The couplers 41, 51 may be used for coupling to the positive terminal and the negative terminal of the spare battery 20 or of the battery 20 (FIG. 3) of a vehicle, for example. The other couplers 42, 52 may be used for coupling to the positive terminal and the negative terminal of the battery 21 (FIG. 3) of a vehicle which may not be used for starting the vehicle.

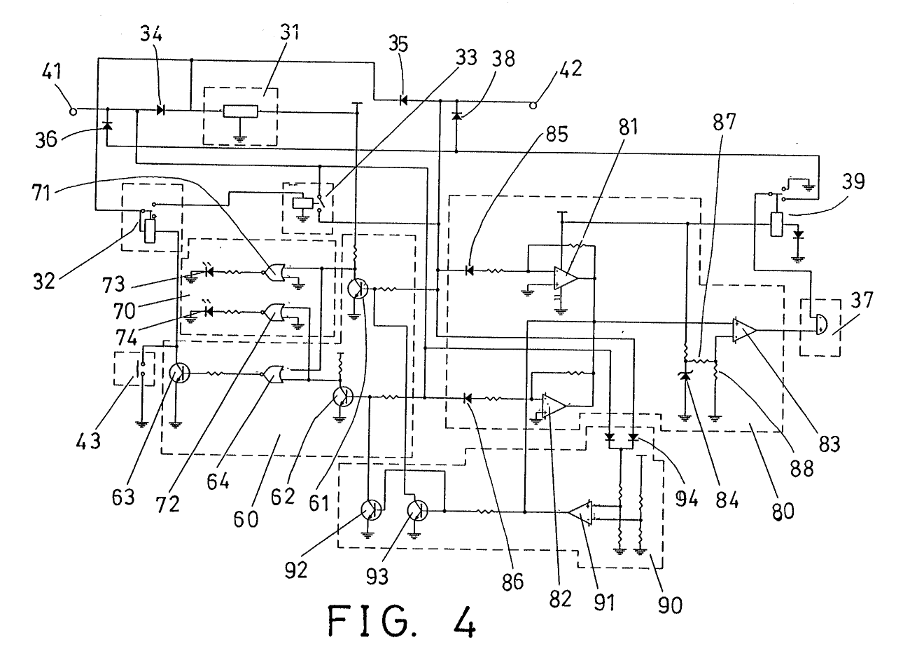

Referring next to FIGS. 3 and 4, the protective device 3 includes a power device 31, such as a battery, for providing the energy to energize the protective device 3. A control device, such as a relay 33 is coupled between the couplers 41, 42, and may be used for selectively and electrically coupling the couplers 41, 42 together, and for selectively shut-off the electric circuit between the couplers 41, 42. Another control device, such as a relay 32 is coupled between the coupler 41 and the relay 33, for selectively actuating the relay 33.

A positive voltage detecting device 60 includes two actuating members, such as transistors 61, 62 which have the bases coupled to the couplers 41, 42 respectively and which have the collectors coupled to a comparator gate 64. The positive voltage detecting device 60 includes another actuating member, such as a transistor 63 which has a base coupled to the comparator gate 64 and which has a collector coupled to the relay 32, for determining whether the relay 32 has been actuated or not.

In operation, when the couplers 41, 42, 51, 52 have been correctly coupled to the correct terminals of the batteries 20, 21 or have been correctly coupled to the electric poles of power suppliers, a positive voltage, such as a voltage greater than 0.7 v, may be applied to the bases of the actuating members 61, 62 and may be used to actuate the actuating members 61. 62, which may then actuate the comparator gate 64 to send out a positive voltage, such as a voltage greater than 0.7 v, to actuate the relay 32 and then to actuate the relay 33. The relay 33 may thus electrically couple the couplers 41, 42 together.

On the contrary, when either or all of the couplers 41, 42, 51, 52 have been wrongly coupled to the terminals of the batteries 20, 21, a voltage less than 0.7 v or even no positive voltage may be applied to the bases of the actuating members 61, 62, such that either or all of the actuating members 61. 62 may not be actuated, and such that the comparator gate 64 may not be used to send out a positive voltage or a signal to actuate the relay 32 and the relay 33. The relay 33 thus may not be used to electrically couple the couplers 41, 42 together, such that the batteries 20, 21 will not be electrically coupled together.

A negative voltage detecting device 80 includes two inverting amplifiers 81, 82 coupled to the couplers 41, 42 respectively with diodes 85, 86 which may shut-off or may block the electric current to the inverting amplifiers 81, 82 when the couplers 41, 42, 51, 52 have been correctly coupled to the correct terminals of the batteries 20, 21 or have been correctly coupled to the electric poles of power suppliers. At this moment, no electric current may flow through the inverting amplifiers 81, 82. A comparator 83 is coupled to the inverting amplifiers 81, 82. A stabilizer member 84 and two resistors 87, 88 may be coupled between the comparator 83 and a warning device 37, such as a buzzer, a flash light or the like, for providing a reference potential or a reference signal and for disabling the warning device 37 when no electric current flow through the inverting amplifiers 81, 82.

In operation, when the couplers 41, 42, 51, 52 have been wrongly coupled to the terminals of the batteries 20, 21, a negative voltage may flow through the diodes 85, 86 and then through the inverting amplifiers 81, 82 which may invert or change the negative voltage into a positive voltage or into an actuating signal. When this actuating signal is greater than the reference signal generated by the stabilizer member 84 and the resistors 87, 88, this actuating signal may be used to actuate and to energize the warning device 37.

An automatic shut-off or protective device 90 includes a comparator 91 having inputs coupled to the couplers 41, 42 with diodes 94, for example, and having an output coupled to the comparator 83 of the negative voltage detecting device 80, for actuating the comparator 83 to energize the warning device 37 when an actuating signal has been generated by the comparator 91 and when either or all of the couplers 41, 42, 51, 52 have been wrongly coupled to the terminals of the batteries 20, 21. The output of the comparator 91 is coupled to two breaking or shut-off members 92, 93, such as coupled to the bases of the transistors 92, 93. The collectors of the transistors 92, 93 are coupled to the bases of the transistors 61, 62 of the positive voltage detecting device 60 for disabling or grounding the transistors 61, 62 when either or all of the transistors 92, 93 are actuated or energized. The electric coupling between the couplers 41, 42 may thus be shut off when the transistors 61, 62 are grounded or disabled.

The power device 31 is coupled to the couplers 41, 42 with diodes 34, 35, and is also coupled to the couplers 41, 42 with the other two diodes 36, 38 which are disposed in a direction opposite to that of the diodes 34, 35. The power device 31 may be coupled to the positive and the negative voltage detecting devices 60, 80 via stabilizing circuits or devices (not shown) for providing a stabilized power supply to the positive and the negative voltage detecting devices 60, 80. When the couplers 41, 42 are wrongly coupled to the terminals of the batteries 20, 21, a negative voltage or signal may be transmitted through the oppositely disposed diodes 36, 38 and then transmitted to a relay 39 in order to actuate the warning device 37 when the power device 31 has no electricity.

An indicating circuit 70 is further provided and includes two gates 71, 72 coupled to the collectors of the transistors 61, 62 of the positive voltage detecting devices 60. The gates 71, 72 each includes an output coupled to an indicating device 73, 74, such as a light emitting diode, a light bulb, a buzzer, or the like. When either of the transistors 61, 62 of the positive voltage detecting devices 60 is energized or actuated, either of the gates 71, 72 may be actuated to energize either of the indicating devices 73, 74, in order to indicate that the couplers 41, 42 have been clamped onto the correct terminals of the batteries 20, 21.

A switch 43, such as a hand-actuated switch 43 is further provided and coupled in parallel to the transistor 63, and is used for compulsorily electrically coupling the couplers 41, 42 together, when no electricity may be supplied to the positive and the negative voltage detecting devices 60, 80.

In operation, when the couplers 41, 42 are wrongly clamped onto the terminals of the batteries 20, 21, the relay 33 will not be actuated, the automatic shut-off or protective device 90 will shut off or open the electric coupling between the couplers 41, 42. In addition, the warning device 37 may be actuated to generate a warning sound or a warning light or the other warning signal, such that the users may know that the couplers 41, 42 have been wrongly clamped onto the terminals of the batteries 20, 21. When the couplers 41, 42 are correctly clamped onto the terminals of the batteries 20, 21, or have been correctly coupled to the electric poles of power suppliers, or have been coupled to the same positive poles or the same negative poles, the relay 33 will be actuated to electric couple the couplers 41, 42 together, and the indicating devices 73, 74 may be used to indicate that the couplers 41, 42 have been correctly clamped onto the terminals of the batteries 20, 21, or have been correctly coupled to the electric poles of power suppliers. The electric circuit between the couplers 41, 42 may be closed after the couplers 41, 42 have been correctly clamped onto the terminals of the batteries 20, 21, or have been correctly coupled to the electric poles of power suppliers, such that no sparks will be generated between the couplers 41, 42 and the terminals of the batteries 20, 21.

Accordingly, the jumper cable apparatus in accordance with the present invention includes a protective device for preventing the terminals of the spare battery from being wrongly coupled to the terminals of the vehicle.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A jumper cable apparatus comprising:
a first coupler,
a second coupler, and
means for electrically coupling said first and said second couplers together when said first and said second couplers are coupled to correct electric poles.

2. The jumper cable apparatus according to claim 1 further comprising means for generating an indicating signal to indicate that said first and said second couplers have been coupled to correct electric poles.

3. A jumper cable apparatus comprising:
a first coupler,
a second coupler, and
means for shutting off an electric coupling between said first and said second couplers when said first and said second couplers are wrongly coupled to electric poles.

4. The jumper cable apparatus according to claim 3, wherein said shutting off means includes a first relay coupled between said first and said second couplers, and means for actuating said first relay.

5. The jumper cable apparatus according to claim 4, wherein said actuating means includes a second relay coupled to said first relay for actuating said first relay.

6. The jumper cable apparatus according to claim 5, wherein said actuating means includes a positive voltage detecting device coupled to said second relay for actuating said second relay when said first and said second couplers have been correctly coupled to the electric poles.

7. The jumper cable apparatus according to claim 6 further comprising means for indicating a correct coupling of said first and said second couplers to the electric poles.

8. The jumper cable apparatus according to claim 3 further comprising means for generating a warning signal when said first and said second couplers are wrongly coupled to the electric poles.

9. The jumper cable apparatus according to claim 8 further comprising a negative voltage detecting device coupled between said first and said second couplers and coupled to said warning signal generating means for actuating said warning signal generating means when said first and said second couplers are wrongly coupled to the electric poles.

10. The jumper cable apparatus according to claim 9 further comprising a protective device coupled to said negative voltage detecting device for shutting off the an electric coupling between said first and said second couplers when said negative voltage detecting device is actuated.

11. The jumper cable apparatus according to claim 10 further comprising a positive voltage detecting device including a first transistor and a second transistor coupled to said first and said second couplers respectively, said positive device including a third and a fourth transistors coupled to said first and said second transistors for selectively disabling said first and said second transistors.

12. The jumper cable apparatus according to claim 3 further comprising means for compulsorily electrically coupling said first and said second couplers together.
